(19) United States
(12) Patent Application Publication
(10) Pub. No.: US 2025/0021353 A1
(43) Pub. Date: Jan. 16, 2025

(54) OBJECT PROCESSING METHOD, ELECTRONIC DEVICE, AND MEDIUM

(71) Applicant: Beijing Zitiao Network Technology Co., Ltd., Beijing (CN)

(72) Inventors: Meng YU, Beijing (CN); Qing LV, Beijing (CN)

(21) Appl. No.: 18/712,178

(22) PCT Filed: Dec. 29, 2022
(86) PCT No.: PCT/CN2022/143116

§ 371 Date: May 21, 2024

(30) Foreign Application Priority Data
Jan. 6, 2022 (CN) 202210010210.3

(51) Int. Cl. G06F 9/451; G06F 3/0482

(52) U.S. Cl. CPC G06F 9/451; G06F 3/0482

(57) ABSTRACT

An object processing method and apparatus, an electronic device and a medium are provided. The method includes: displaying an object-to-be-processed selection interface; in response to a confirmation control in the object-to-be-processed selection interface being triggered, displaying an initial attribute selection interface of a selected object to be processed; in response to the target attribute control in the initial attribute selection interface being triggered, displaying an initial attribute changing interface; and in response to a processing of the selected object to be processed through the initial attribute changing interface satisfying a first preset condition, displaying a target attribute processing interface.

### CROSS-REFERENCE TO RELATED APPLICATION

The present application claims priority of the Chinese Patent Application No. 202210010210.3, filed on Jan. 6, 2022, the entire disclosure of which is incorporated herein by reference as part of the present application.

### TECHNICAL FIELD

Embodiments of the present disclosure relate to the field of Internet technology, and for example, to an object processing method and apparatus, an electronic device, and a medium.

### BACKGROUND

With the advent of the information age, the “external world” in which people live is no longer just “nature”. In the virtual world of the Internet, some “objects” have visual effects that people can observe through the screen. These “objects” can be “present” continuously and stably in the network environment, for example, as a commodity on an online store.

At this stage, users can process the commodity on the online store. When processing the commodity on the online store, the commodity to be processed (also known as the object to be processed) can be processed in a single way, such as only setting attributes of the object to be processed, resulting in the poor interaction experience of users when dealing with the object to be processed.

### SUMMARY

Embodiments of the present disclosure provide an object processing method and apparatus, an electronic device, and a medium to improve a user's experience in performing processing of an object to be processed.

In a first aspect, an embodiment of the present disclosure provides an object processing method, and the method includes:
displaying an object-to-be-processed selection interface;
in response to determining that a confirmation control in the object-to-be-processed selection interface is triggered, displaying an initial attribute selection interface of a selected object to be processed, where the initial attribute selection interface includes an initial attribute control and a target attribute control, and the initial attribute control is configured to process the selected object to be processed with an initial attribute;
in response to determining that the target attribute control in the initial attribute selection interface is triggered, displaying an initial attribute changing interface; and
in response to determining that a processing of the selected object to be processed through the initial attribute changing interface satisfies a first preset condition, displaying a target attribute processing interface, where the target attribute processing interface is provided for a user to process the selected object to be processed with a target attribute.

In a second aspect, an embodiment of the present disclosure further provides an object processing apparatus, and the apparatus includes:
a first display module, configured to display an object-to-be-processed selection interface;
a second display module, configured to, in response to determining that a confirmation control in the object-to-be-processed selection interface is triggered, display an initial attribute selection interface of a selected object to be processed, where the initial attribute selection interface includes an initial attribute control and a target attribute control, and the initial attribute control is configured to process the selected object to be processed with an initial attribute;
a third display module, configured to, in response to determining that the target attribute control in the initial attribute selection interface is triggered, display an initial attribute changing interface; and
a fourth display module configured to, in response to determining that a processing of the selected object to be processed through the initial attribute changing interface satisfies a first preset condition, display a target attribute processing interface, where the target attribute processing interface is provided for a user to process the selected object to be processed with a target attribute.

In a third aspect, an embodiment of the present disclosure further provides an electronic device, and the electronic device includes:
one or more processing apparatuses;
a storage apparatus configured to store one or more programs,
where the one or more programs upon being executed by the one or more processing apparatuses implement the object processing method provided by embodiments of the present disclosure.

In a forth aspect, an embodiment of the present disclosure further provides a computer readable medium storing computer programs, the computer programs upon being executed by a processing apparatus, implement the object processing method provided by embodiments of the present disclosure.

### BRIEF DESCRIPTION OF DRAWINGS

In the drawings throughout, same or similar drawing reference signs represent same or similar elements. It should be understood that the drawings are schematic, and originals and elements may not necessarily be drawn to scale.

FIG. 1 is a flow schematic diagram of an object processing method provided in an embodiment of the present disclosure;

FIG. 2 is a schematic diagram of an object-to-be-processed selection interface provided in an embodiment of the present disclosure;

FIG. 3 is a schematic diagram of an initial attribute selection interface provided in an embodiment of the present disclosure;

FIG. 4 is a schematic diagram of an initial attribute changing interface provided in an embodiment of the present disclosure;

FIG. 5 is a schematic diagram of an intermediate attribute selection interface provided in an embodiment of the present disclosure;

FIG. 6 is a schematic diagram of a reprocessing selection interface provided in an embodiment of the present disclosure;

FIG. 7 is a schematic diagram of an animation for changing an attribute provided in an embodiment of the present disclosure;

FIG. 8 is a flow schematic diagram of an object processing method provided in another embodiment of the present disclosure;

FIG. 9 is a schematic diagram of an interface of a time-limited processing provided in an embodiment of the present disclosure;

FIG. 10 is a schematic diagram of an interface for displaying a second sharing control within an attribute changing interface provided in an embodiment of the present disclosure;

FIG. 11 is a structural schematic diagram of an object processing apparatus provided in an embodiment of the present disclosure; and

FIG. 12 is a structural schematic diagram of an electronic device provided in an embodiment of the present disclosure.

### DETAILED DESCRIPTION

It should be understood that a plurality of steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise stated in the context, it should be understood as “one or more”.

Names of messages or information exchanged between a plurality of apparatuses in embodiments of the present disclosure are only used for the purpose of description and not meant to limit the scope of these messages or information.

Both of example features and example embodiments are provided in the embodiments as will be described below. A plurality of features described in the embodiments may be combined to form a plurality of example solutions. Each numbered embodiment shall not be merely considered as a technical solution.

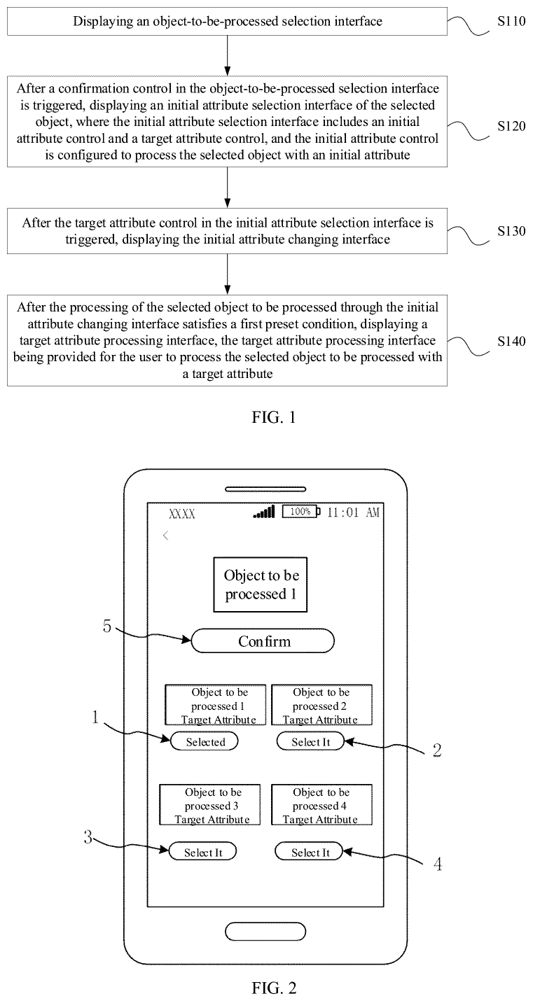

FIG. 1 is a flow schematic diagram of an object processing method provided in an embodiment of the present disclosure, the method may be applied to processing of an object to be processed and may be performed by an object processing apparatus, the apparatus may be implemented by software and/or hardware and is generally integrated on an electronic device. In this embodiment, the electronic device includes, but is not limited to, a computer, a laptop, a tablet, a mobile phone, and the like.

As shown in FIG. 1, an embodiment of the present disclosure provides an object processing method, including the following steps.
S110: displaying an object-to-be-processed selection interface.

In the present embodiment, the object to be processed may refer to anything on a network that is used and consumed by people and can satisfy a certain need, and the object to be processed includes a tangible item, an intangible service, an organization, an idea, and/or a combination thereof, and the like. In an example, the object to be processed may be a commodity.

The object-to-be-processed selection interface may refer to an interface where the user selects an object to be processed.

For example, the object-to-be-processed selection interface may include an object to be processed, a target attribute corresponding to the object to be processed, an object-to-be-processed selection control, and an object-to-be-processed confirmation control. The object-to-be-processed selection control may be a control used by a user to select an object to be processed. For example, it may be a key, or may be embedded in an image of the object to be processed, and the object to be processed is selected when the user clicks a button or the image of the object to be processed. The object-to-be-processed confirmation control may be a control for confirming selection of the object to be processed by a user, which is used to trigger display of a next interface (such as an initial attribute selection interface).

The target attribute may be an attribute of the object to be processed when it is being processed. Different objects to be processed correspond to different target attributes. For example, the object to be processed may be a commodity. The target attribute may be a lowest attribute that a platform can provide when a user processes the object to be processed, such as a lowest discount.

The target attributes corresponding to individual objects to be processed may be the same or different. For example, when the object to be processed is a commodity, the target attribute corresponding to the object to be processed may be a 90%-off discount.

It may be noted that, in the present embodiment, in an object-to-be-processed selection interface, one or more objects to be processed are provided for selection by a user. Each object to be processed corresponds to a target attribute, and when the user needs to process a certain object to be processed, the user may access the object-to-be-processed selection interface, and select the object to be processed through the object-to-be-processed selection control for subsequent processing.

The present embodiment does not limit the form in which the content corresponding to the selected object to be processed is displayed (including the object-to-be-processed selection control, the image of the object to be processed image, and the like), as long as the content corresponding to the selected object to be processed may be distinguished from the content corresponding to the unselected objects to be processed. As an example, after the object to be processed is selected, the information displayed by the object-to-be-processed selection control may change to “Selected”, or the image of the selected object to be processed turns gray to distinguish from the unselected objects to be processed, where the user may trigger the object-to-be-processed confirmation control, that is, the confirmation control to confirm the selected object to be processed, and trigger subsequent operations.

FIG. 2 is a schematic diagram of an object-to-be-processed selection interface provided in an embodiment of the present disclosure. As shown in FIG. 2, the object-to-be-processed selection interface includes object-to-be-processed selection controls 1, 2, 3 and 4, and an object-to-be-processed confirmation control 5, where the object-to-be-processed selection controls 1, 2, 3 and 4 may be controls for the user to select an object to be processed, and the object-to-be-processed confirmation control 5 may be a control for the user to confirm selection of the object to be processed for triggering display of a next interface (such as an initial attribute selection interface). As shown in FIG. 2, the target attribute may be different based on the object to be processed. Taking the object to be processed as a commodity, the target attribute may be a target discount, or a price corresponding to the target discount.
S120: after a confirmation control in the object-to-be-processed selection interface is triggered, displaying an initial attribute selection interface of the selected object, where the initial attribute selection interface includes an initial attribute control and a target attribute control, and the initial attribute control is configured to process the selected object with an initial attribute.

The initial attribute may be understood as an internal attribute set by the platform for the user to process the object to be processed. For example, the initial attribute may be understood as the internal price set on the platform for the user to trade the commodity. The initial attribute selection interface may be understood as an interface in which a user may select to process the object to be processed with the initial attribute, and the initial attribute selection interface may include an initial attribute control and a target attribute control, the initial attribute control may refer to a control in which the user confirms the selection to process the object with the initial attribute, and the target attribute control may refer to a control in which the user selects not to process the object with the initial attribute and continues to process the object with the target attribute.

After the object-to-be-processed confirmation control in the object-to-be-processed selection interface is triggered, the initial attribute selection interface of the selected object to be processed may be displayed. In the initial attribute selection interface, the user may select to trigger the initial attribute control or the target attribute control to confirm whether to process the objected to be processed with the initial attribute. For example, when the user selects to trigger the initial attribute control, indicating that the user confirms that the object to be processed is processed with the initial attribute, and then enters the processing interface to process the object to be processed. Accordingly, when the user selects to trigger the target attribute control, indicating that the user confirms that the object to be processed is not processed with the initial attribute, and selects to continue to complete the operation of processing with the target attribute, an initial attribute changing interface may be displayed for subsequent operations.

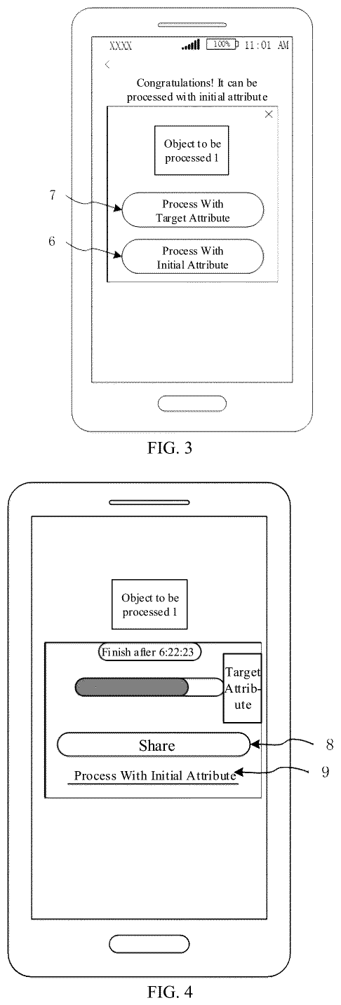

FIG. 3 is a schematic diagram of an initial attribute selection interface provided in an embodiment of the present disclosure. As shown in FIG. 3, the initial attribute selection interface includes an initial attribute control 6 and a target attribute control 7, where the initial attribute control 6 may be configured as a control for the user to confirm the selection of processing the object to be processed with the initial attribute, and the target attribute control 7 may be a control for the user to select not to process the object to be processed with the initial attribute and to continue the subsequent target attribute operation. For example, if the object to be processed is a commodity, the initial attribute may be a 15%-off discount, and the target attribute may be a 90%-off discount.
S130: after the target attribute control in the initial attribute selection interface is triggered, displaying the initial attribute changing interface.

The initial attribute changing interface may be understood as an interface where the user starts with the initial attribute in order to reach the target attribute. The initial attribute changing interface may include a progress bar that shows a distance from the target attribute. The initial attribute changing interface may also include a task control, a first sharing control, and the like, that may be used to reach the target attribute by completing the processing of the object to be processed (such as completing a task or sharing to friends for help, and the like). The initial attribute changing interface may also include an initial processing control provided for the user to choose to process the object to be processed with the initial attribute.

For example, the initial attribute changing interface includes an initial processing control, an initial attribute processing interface is displayed after the initial processing control is triggered, and the initial attribute processing interface is provided for the user to process the selected object with the initial attribute.

The initial processing control may be understood as a control in which the user chooses to process the object to be processed with the initial attribute, and the initial attribute processing interface may refer to an interface where the user processes the object to be processed with the initial attribute. For example, the user may trigger the initial processing control in the initial attribute changing interface to display the initial attribute processing interface. The user may then process the selected object to be processed with the initial attribute through the initial attribute processing interface.

For example, the initial attribute changing interface includes a first sharing control, a sharing interface is displayed after the first sharing control is triggered.

After a sharing operation in the sharing interface is received, the sharing operation is responded.

The first sharing control may refer to a control on which a user requests to perform a sharing operation. The present embodiment does not limit the first sharing control. For example, the first sharing control may be a control in the form of an arrow to indicate the user to perform a sharing operation, and may also represent the sharing control in the form of words, such as “Share”. The sharing operation refer to a sharing operation of a user. For example, it may be an operation in which the user shares to a sharing object to complete the help, including the operation of selecting a sharing object and confirming the sharing, and the like. The sharing object may be a friend on the software and/or other application software used by the current user to process the object to be processed, or a friend nearby who has not been added, or a group chat or discussion group on a software used by the current user to process the object to be processed and/or another application software, which is not limited in the present embodiment. The sharing interface may refer to an interface on which the user performs a sharing operation, and may include one or more sharing objects, a sharing confirmation control, and the like. As an example, when the first sharing control in the initial attribute changing interface is triggered, the sharing interface is displayed, and the user can complete the sharing operation in the sharing interface. After the sharing operation in the sharing interface is received, the user can respond to the sharing operation to share the content to the sharing object.

For example, after the target attribute control is triggered in the initial attribute selection interface, the initial attribute changing interface may be displayed, so that the user can select a control to be triggered in the initial attribute changing interface to perform the corresponding operation. FIG. 4 is a schematic diagram of an initial attribute changing interface provided in an embodiment of the present disclosure. As shown in FIG. 4, the initial attribute changing interface includes a first sharing control 8 and an initial processing control 9, where a user can trigger the initial processing control 9 to process the selected object to be processed with an initial attribute, and the user may trigger the first sharing control 8 to perform a sharing operation.
S140: after the processing of the selected object to be processed through the initial attribute changing interface satisfies a first preset condition, displaying a target attribute processing interface, the target attribute processing interface being provided for the user to process the selected object to be processed with a target attribute.

The first preset condition may be understood as a condition that the user needs to satisfy in order to process the object to be processed with the target attribute. For example, it may include inviting a high-value sharing object or inviting a new user to the platform, and the like. The first preset condition may be set by the system or a relevant person, which is not limited herein. The target attribute processing interface may be an interface in which the user processes the object to be processed with the target attribute.

The present disclosure does not limit the method of determining the value, and it can be determined according to actual needs.

It may be understood that, in the initial attribute changing interface, the user may process the selected object to be processed to satisfy the first preset condition by means such as triggering the first sharing control. The present embodiment does not limit the timing of satisfying the first preset condition. For example, the first preset condition may be considered as being satisfied when the response result satisfies the first preset condition during the process of processing the selected object to be processed.

For example, when the processing of the selected object to be processed by the user through the initial attribute changing interface satisfies the first preset condition, the target attribute processing interface may be displayed, and the user can process the selected object to be processed with the target attribute through the target attribute processing interface. For example, when the processing of the selected object to be processed through the initial attribute changing interface satisfies the first preset condition, a preset condition satisfaction interface may first be displayed to clearly inform the user that the first preset condition is satisfied, and then the target attribute processing interface may be displayed, where the user may process the selected object to be processed with the target attribute through the target attribute processing interface.

Embodiments of the disclosure provide an object processing method, and the method includes: displaying an object-to-be-processed selection interface, after a confirmation control in the object-to-be-processed selection interface is triggered, displaying an initial attribute selection interface for the selected object to be processed, the initial attribute selection interface including an initial attribute control and a target attribute control, and the initial attribute control being configured to process the selected object to be processed with an initial attribute; after the target attribute control in the initial attribute selection interface is triggered, displaying an initial attribute changing interface; and after the processing of the selected object to be processed through the initial attribute changing interface satisfies a first preset condition, displaying a target attribute processing interface, where the target attribute processing interface is provided for the user to process the selected object to be processed with a target attribute. Using the above method, by setting the initial attribute control and a target attribute control in the initial attribute selection interface, the object to be processed may be processed with the initial attribute and target attribute, thereby improving the user experience of processing the object to be processed.

Based on the above embodiment, a variant embodiment of the above embodiment is proposed. It is noted here that to simplify the description, only the differences with the above embodiment are described in the variant embodiment.

In an embodiment, when the response result satisfies a second preset condition, an intermediate attribute selection interface is displayed, where the intermediate attribute selection interface includes an intermediate attribute control and a target attribute control, and the intermediate attribute control is configured to process the selected object to be processed with an intermediate attribute.

After the target attribute control is triggered in the intermediate attribute selection interface, an intermediate attribute changing interface is displayed.

The second preset condition may be regarded as an intermediate critical value to be satisfied by the user's processing of the selected object to be processed through the initial attribute changing interface, which may be used to determine whether the selected object to be processed may be processed with intermediate attribute. The second preset condition may be set by the system or a relevant person, which is not limited herein.

The intermediate attribute may be understood as an intermediate attribute set by the platform for the user to process the object to be processed. For example, the intermediate attribute may be understood as an intermediate discount set on the platform for the user to trade the commodity. The value of the intermediate attribute may be less than the data corresponding to the initial attribute and greater than the value corresponding to the target attribute. For example, when the initial attribute is a 15%-off discount and the target attribute is a 90%-off discount, the intermediate attribute may be a 65%-off discount.

Different objects to be processed may correspond to different intermediate attributes, and the intermediate attribute may be determined by the platform through any means, which is not limited herein.

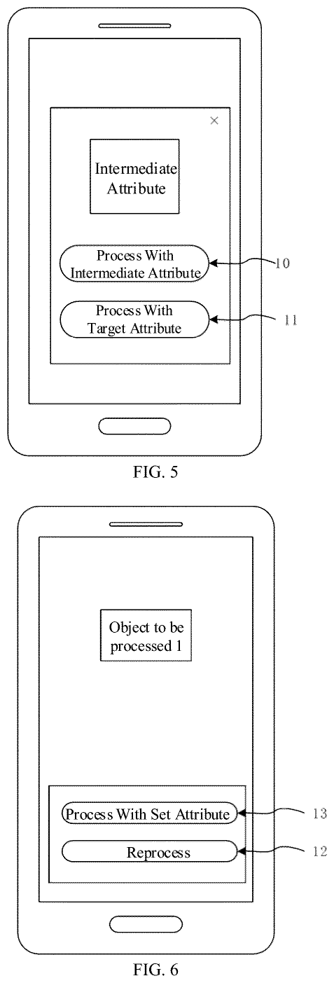

The intermediate attribute selection interface may be an interface for the user to select whether or not to process the object to be processed with the intermediate attribute. FIG. 5 is a schematic diagram of an intermediate attribute selection interface provided in an embodiment of the present disclosure. As shown in FIG. 5, the intermediate attribute selection interface may include an intermediate attribute control 10 and a target attribute control 11, where the intermediate attribute control 10 may be a control indicating that the user confirms the selection of processing the object to be processed with the intermediate attribute, and the target attribute control 11 may be a control indicating that the user selects not to process the object to be processed with the intermediate attribute and proceeds with subsequent target attribute operation.

The intermediate attribute changing interface may be understood as an interface where the user starts with an intermediate attribute or with an attribute that the user has already obtained in order to obtain a target attribute, and the intermediate attribute changing interface may include a progress bar to show a distance from the target attribute. The intermediate attribute changing interface may also include a task control, a sharing control, and the like, to continue to reach the target attribute by completing the task or sharing it with a sharing object, and the like, and the intermediate attribute changing interface may also include an intermediate processing control for the user to choose to process the object with the intermediate attribute.

For example, after the target attribute control is triggered in the intermediate attribute selection interface, the intermediate attribute changing interface may be displayed, so that the user can choose to trigger a control in the intermediate attribute changing interface to perform a corresponding operation.

In an embodiment, the intermediate attribute changing interface includes an intermediate processing control, where an intermediate attribute processing interface may be displayed after the intermediate processing control is triggered, and the intermediate attribute processing interface is provided for the user to process the object to be processed with the intermediate attribute.

The intermediate processing control may be understood as a control in which the user may choose to process the object to be processed with the intermediate attribute, and the intermediate attribute processing interface may refer to an interface where the user processes the object to be processed with the intermediate attribute. For example, the user may trigger the intermediate processing control in the intermediate attribute changing interface to display the intermediate attribute processing interface. The user may then process the selected object to be processed with the intermediate attribute through the intermediate attribute processing interface.

In an embodiment, after the processing of the selected object to be processed through the initial attribute changing interface satisfies a first preset condition, the displaying a target attribute processing interface includes:

when a response result satisfies the first preset condition during the processing of the selected object to be processed, displaying the target attribute processing interface.

The response result may refer to a cumulative result of responding to the processing on the selected object to be processed, such as the cumulative response result of sharing operations, such as the cumulative number of sharing to a sharing object, or the cumulative number of specific tasks that have been completed. As an example, when a specific number of sharing objects are invited and/or a specific number of specific tasks are completed cumulatively, the first preset condition may be considered as being satisfied. The specific task may be a task set by the application platform. Alternatively, in the process of inviting a sharing object and/or completing a specific task, the system converts the invited sharing object and/or the completed task into a value on the platform, and when the cumulative value is greater than or equal to a target threshold, the first preset condition may be considered as being satisfied. The target threshold is not limited in this step.

For example, when a response result satisfies the first preset condition during the processing of the selected object to be processed, the target attribute processing interface may be displayed for the user to process the selected object to be processed with the target attribute.

In an embodiment, when the response result satisfies a third preset condition within a set duration, a reprocessing selection interface is displayed, where the reprocessing selection interface includes a reprocessing control and a set attribute control. The initial attribute changing interface is displayed again after the reprocessing control is triggered, the corresponding attribute processing interface is displayed after the set attribute control is triggered, and the attribute processing interface is provided for the user to process the selected object to be processed with a set attribute.

In this embodiment, the set duration may refer to a duration threshold value for the user to process the object to be processed. The third preset condition may be understood as a critical value of the response result when the target attribute is not reached, and the set duration and the third preset condition may be set by the system or a relevant person, which are not limited herein.

The reprocessing selection interface may be understood as an interface in which the user selects whether to display the initial attribute change again. The reprocessing selection interface may include a reprocessing control and a set attribute control. The reprocessing control may be understood as a control in which the user needs to restart the processing of the object to be processed, and the set attribute control may be understood as a control in which the user selects to process the object to be processed with the set attribute. The set attribute may be understood as an attribute with the smallest value in the attributes that the user has obtained, such as an initial attribute or an intermediate attribute. The attribute processing interface may refer to an interface where the user processes the object to be processed with the set attribute.

For example, when the response result satisfies the third preset condition within the set duration, indicating that the user has not obtained the target attribute within the set duration, the reprocessing selection interface may be displayed, and the user may trigger the reprocessing control or the set attribute control in the reprocessing selection interface to perform the corresponding operation.

FIG. 6 is a schematic diagram of a reprocessing selection interface provided in an embodiment of the present disclosure. As shown in FIG. 6, the reprocessing selection interface includes a reprocessing control 12 and a set attribute control 13. When the user triggers the reprocessing control 12, the initial attribute changing interface may be displayed again to reprocess the object to be processed. When the user triggers the set attribute control 13, the corresponding attribute processing interface may be displayed, and then the user can process the selected objected to be processed with the set attribute through the attribute processing interface.

The processing the object to be processed may be understood as trading the object to be processed.

In an embodiment, before displaying the initial attribute changing interface after the target attribute control in the initial attribute selection interface is triggered, the method further includes:

displaying an animation of an attribute change during the processing of the object to be processed.

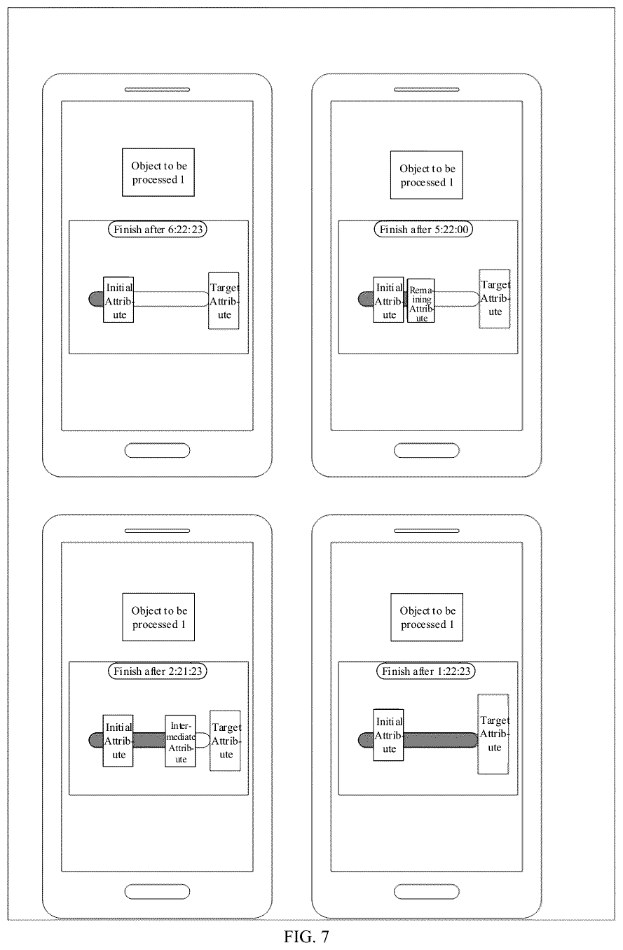

The attribute changing animation may be understood as steps that the user needs to go through to complete the processing of the selected object to be processed to satisfy the first preset condition, so that the user can more clearly understand the whole process of satisfying the first preset condition. For example, after the target attribute control in the initial attribute selection interface is triggered and before displaying the initial attribute changing interface, an attribute changing animation in the process of processing the object to be processed may be displayed. After the attribute changing animation is played, the initial attribute changing interface may be directly entered, and a starting control may also be added to trigger the display of the initial attribute changing interface. FIG. 7 is a schematic diagram of an attribute changing animation provided in an embodiment of the present disclosure, and FIG. 7 is an example diagram that describes the exemplary process that the user starts from an initial attribute to get to remaining attribute, an intermediate attribute, and then to a target attribute. The user can more clearly understand the whole process of satisfying the first preset condition by displaying the attribute changing animation. FIG. 7 illustrates only some frames in the animation as an example, and the order in which the frames appear is as follows: an interface in the upper left corner that corresponds to the initial attribute, an interface in the upper right corner that corresponds to the remaining attributes, an interface in the lower left corner that corresponds to the intermediate attribute, and an interface in the lower right corner that corresponds to the target attribute. The remaining attributes may be between the initial attribute and the intermediate attribute.

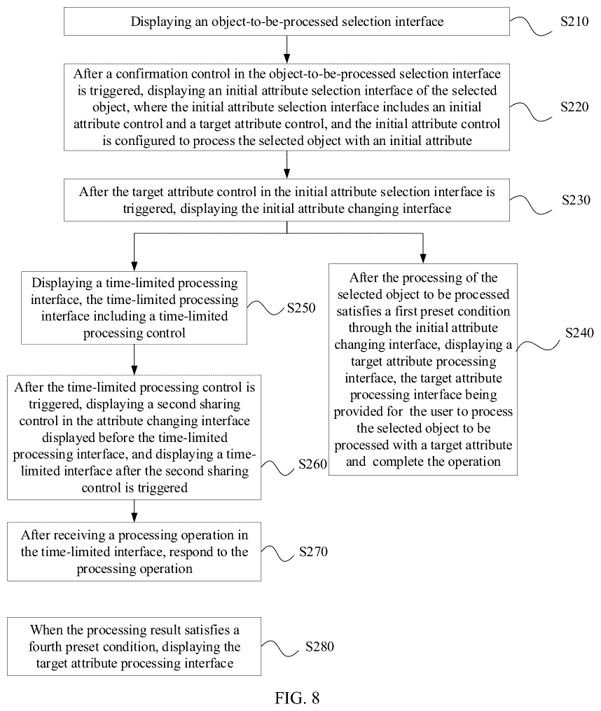

FIG. 8 is a flow schematic diagram of an object processing method processing provided in another embodiment of the present disclosure. The present embodiment is refined on the basis of a plurality of example solutions in the above plurality of embodiments. In this embodiment, after the displaying the initial attribute changing interface after the target attribute control in the initial attribute selection interface is triggered, the method is refined as: displaying a time-limited processing interface, the time-limited processing interface including a time-limited processing interface; displaying a second sharing control in the attribute changing interface displayed before the time-limiting processing interface after the time-limited processing control is triggered; displaying a time-limited interface after the second sharing control is triggered; responding to a processing operation after receiving a processing operation in the time-limiting interface; and displaying a target attribute processing interface when a processing result satisfies a fourth preset condition.

For those not exhaustively described in this embodiment, refer to the above embodiments.

As shown in FIG. 8, an object processing method provided in an embodiment of the present disclosure includes the following steps:
S210: displaying an object-to-be-processed selection interface.
S220: after a confirmation control in the object-to-be-processed selection interface is triggered, displaying an initial attribute selection interface of the selected object, where the initial attribute selection interface includes an initial attribute control and a target attribute control, and the initial attribute control is configured to process the selected object with an initial attribute.
S230: after the target attribute control in the initial attribute selection interface is triggered, displaying the initial attribute changing interface.

In this step, when the target attribute control in the initial attribute selection interface is triggered, the initial attribute changing interface is displayed. In the process from entering the initial attribute changing interface to satisfying a first preset condition, a time-limited processing interface may be displayed, where in the time-limited processing interface, the user can choose whether to perform time-limited processing as required, and after completing the time-limited processing, the user can directly process the selected object to be processed with a target attribute.

As an example, when the user triggers the time-limited processing control in the time-limited processing interface, indicating that the user chooses to perform the time-limited processing, the user can complete the time-limited processing through a second sharing control. When the user does not trigger the time-limited processing control in the time-limited processing interface, indicating that the user chooses to continue to complete the first preset condition, after the user satisfies the first preset condition through the attribute changing interface, the target attribute processing interface is displayed, so that the selected object to be processed is processed with the target attribute in the target attribute processing interface.

For example, the time-limited processing interface may also be a time-limited display interface, and after the time expires, the corresponding control to complete the time-limited processing may be displayed in the attribute changing interface for the user to operate.
S240: after the processing of the selected object to be processed through the initial attribute changing interface satisfies a first preset condition, displaying a target attribute processing interface, the target attribute processing interface being provided for the user to process the selected object to be processed with a target attribute and complete the operation.
S250: displaying a time-limited processing interface, the time-limited processing interface including a time-limited processing control.

For example, the time-limited processing interface may characterize an interface in which the user can choose whether to perform a time-limited processing. For example, the time-limited processing interface may include a time-limited processing control, which may be a control for the user to confirm to perform the time-limited processing. A close control may also be included in the time-limited processing interface. The close control may represent a control that the user confirms not to perform the time-limited processing. A specific task for time-limited processing may also be included in the time-limited processing interface to clearly inform the user of the time-limited operation that needs to be completed, such as inviting several sharing objects. The sharing object invited in this step needs to be a high-value user, such as a new user or a user who installs the application again after uninstalling it. Compared with a sharing-based, the display-based processing control

The present embodiment does not limit the timing of displaying a time-limited processing interface, for example, it can be displayed randomly, or it can be displayed when the user completes a hidden operation. The hidden operation may be understood as an action that is hidden in the system and unknown to the user, and can be preset by the system or a relevant person, which is not limited herein. As an example, the hidden operation may be an operation to complete a task, to complete a set number of tasks, or perform sharing for a set number of times, and the like, which is not limited herein.

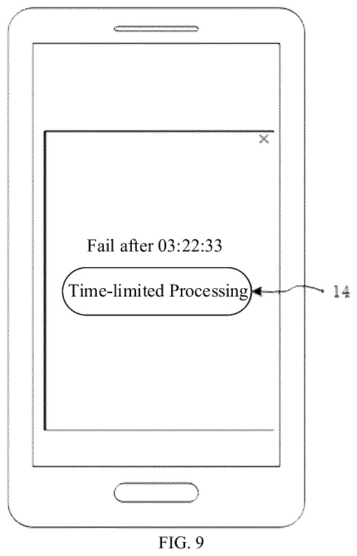

FIG. 9 is a schematic diagram of a time-limited processing interface provided in an embodiment of the present disclosure. As shown in FIG. 9, the time-limited processing interface includes a time-limited processing control 14, configured to characterize the user's confirmation of time-limited processing.
S260: after the time-limited processing control is triggered, displaying a second sharing control in the attribute changing interface displayed before the time-limited processing interface, and displaying a time-limited interface after the second sharing control is triggered.

The attribute changing interface includes an initial attribute changing interface and an intermediate attribute changing interface, where the user may process the selected object to be processed in the initial attribute changing interface before the time-limited processing interface is displayed, or process the selected object to be processed in the intermediate attribute changing interface. The second sharing control may be understood as a sharing control corresponding to the time-limited processing. The time-limited interface may be understood as an interface where the user can perform a sharing operation.

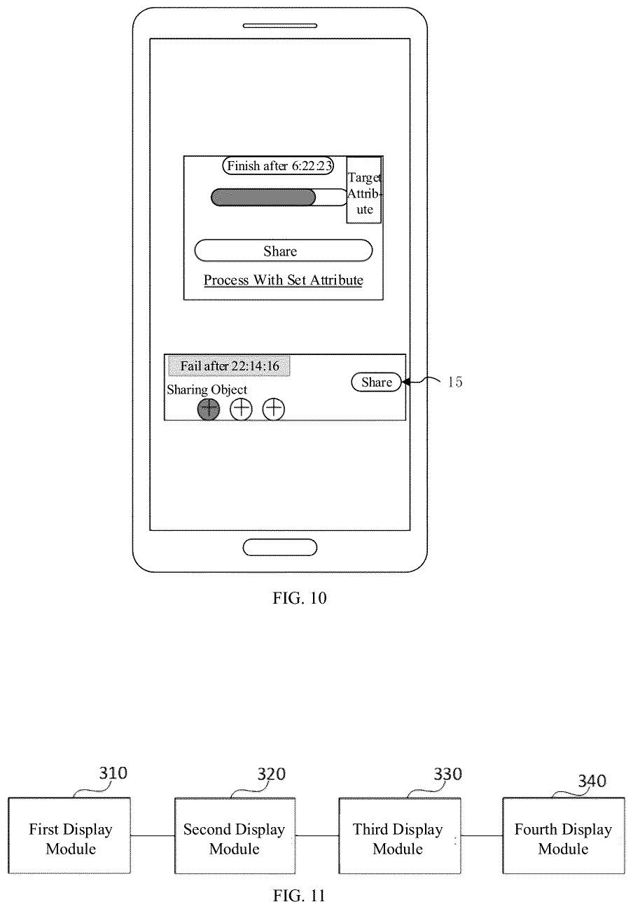

For example, after the time-limited processing control is triggered, the second sharing control may be displayed in the attribute changing interface, and the user can complete the time-limited processing through the second sharing control. FIG. 10 is a schematic diagram of an interface for displaying a second sharing control within an attribute changing interface provided in an embodiment of the present disclosure. As shown in FIG. 10, the second sharing control 15 is displayed in the attribute changing interface, and the user can complete time-limited processing through the second sharing control 15.

In addition, when the time-limited processing control is not triggered, the attribute changing interface may also be displayed directly, and a second sharing control may or may not exist in the attribute changing interface.
S270: after receiving a processing operation in the time-limited interface, respond to the processing operation.

A processing operation may refer to a processing operation corresponding to a time-limited processing. For example, it may be an operation that needs to be performed on a selected object to be processed within a limited time, which is not limited herein. For example, it can be sharing to a sharing object and the like.

For example, the user may perform a processing operation in the time-limited interface. After receiving the processing operation in the time-limited interface, the processing operation may be responded so that the processing result of processing the selected object to be processed satisfies a certain condition.
S280: when the processing result satisfies a fourth preset condition, displaying the target attribute processing interface.

The processing result may refer to a cumulative result of processing operations on the selected object to be processed, that is, the cumulative response result of processing operations, such as the cumulative number of sharing to a sharing object or the cumulative number of specific tasks that have been completed. The fourth preset condition may be understood as the condition that needs to be satisfied by the cumulative result of the processing operations on the selected object to be processed. Exemplarily, when a specific number of sharing objects are invited and/or a specific number of specific tasks are completed cumulatively, the fourth preset condition may be considered as being satisfied. The difficulty of satisfying the fourth preset condition may be lower than that of the first preset condition. The first preset condition may be inviting 5 new users, and the fourth preset condition may be inviting 2 new users.

For example, when the processing result satisfies the fourth preset condition, the target attribute processing interface may be displayed for the user to process the selected object to be processed with the target attribute. The present embodiment does not limit the subsequent steps to process the selected object to be processed with the target attribute.

The embodiment of the present disclosure provides an object processing method, which through setting a time-limited processing interface, can increase the user's sense of surprise in the process of processing the object to be processed, reducing the difficulty of processing the object to be processed with the target attribute for the user.

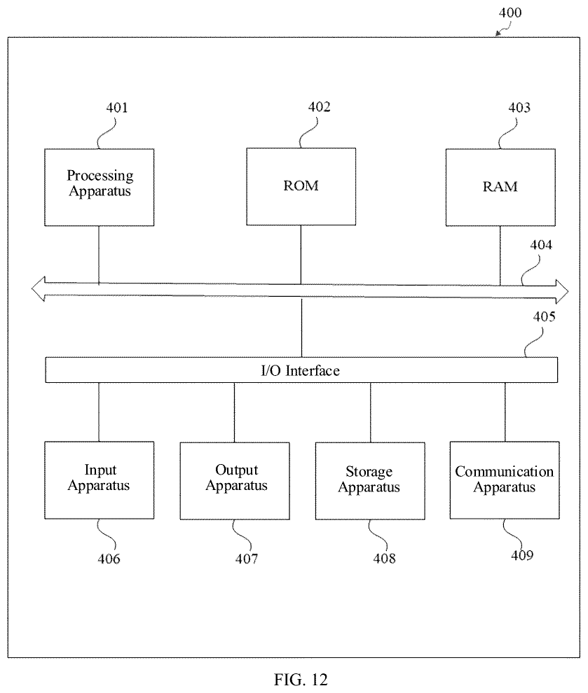

FIG. 11 is a structural schematic diagram of an object processing apparatus provided in an embodiment of the present disclosure. The apparatus may be suitable for processing the object to be processed, the apparatus may be implemented by software and/or hardware, and generally be integrated on an electronic device.

As shown in FIG. 11, the apparatus includes:
a first display module 310 configured to display an object-to-be-processed selection interface;
a second display module 320 configured to display an initial attribute selection interface of a selected object to be processed after a confirmation control in the object-to-be-processed selection interface is triggered, where the initial attribute selection interface includes an initial attribute control and a target attribute control, and the initial attribute control is configured to process the selected object to be processed with an initial attribute;
a third display module 330 configured to display an initial attribute changing interface after the target attribute control in the initial attribute selection interface is triggered; and
a fourth display module 340 configured to display a target attribute processing interface after a processing of the selected object to be processed through the initial attribute changing interface satisfies a first preset condition, where the target attribute processing interface is provided for a user to process the selected object to be processed with a target attribute.

The embodiment of the disclosure provides an object processing apparatus. The apparatus displays through the first display module 310 an object-to-be-processed selection interface, after a confirmation control in the object-to-be-processed selection interface is triggered, displays an initial attribute selection interface of the selected object to be processed through a second display module 320, where the initial attribute selection interface includes an initial attribute control and a target attribute control, and the initial attribute control is configured to process the selected object to be processed with the initial attribute; after the target attribute control in the initial attribute selection interface is triggered, displays an initial attribute changing interface through the third display module 330; and after processing of the selected object to be processed through the initial attribute changing interface satisfies a first preset condition, displays a target attribute processing interface through the fourth display module 340, where the target attribute processing interface is provided for the user to process the selected object to be processed with the target attribute. By using the above apparatus, by setting an initial attribute control and a target attribute control in the initial attribute selection interface, the object to be processed may be processed with the initial attribute and target attribute, thereby improving the user experience of processing the object to be processed.

For example, the initial attribute changing interface includes an initial processing control, an initial attribute processing interface is displayed after the initial processing control is triggered, and the initial attribute processing interface is provided for the user to process the selected object with the initial attribute.

For example, the initial attribute changing interface includes a first sharing control, a sharing interface is displayed after the first sharing control is triggered.

After a sharing operation in the sharing interface is received, the sharing operation is responded.

For example, when a response result satisfies a second preset condition, an intermediate attribute selection interface is displayed, where the intermediate attribute selection interface includes an intermediate attribute control and a target attribute control, and the intermediate attribute control is configured to process the selected object to be processed with an intermediate attribute.

After the target attribute control in the intermediate attribute selection interface is triggered, an intermediate attribute changing interface is displayed.

For example, the intermediate attribute changing interface includes an intermediate processing control, an intermediate attribute processing interface is displayed after the intermediate processing control is triggered, and the intermediate attribute processing interface is provided for the user to process the object to be processed with the intermediate attribute.

For example, the fourth display module 340 is specifically configured to:
when a response result satisfies the first preset condition during the processing of the selected object to be processed, display the target attribute processing interface.

For example, when the response result satisfies a third preset condition within a set duration, a reprocessing selection interface is displayed, where the reprocessing selection interface includes a reprocessing control and a set attribute control. The initial attribute changing interface is displayed again after the reprocessing control is triggered, the corresponding attribute processing interface is displayed after the set attribute control is triggered, and the attribute processing interface is provided for the user to process the selected object to be processed with a set attribute.

For example, before displaying the initial attribute changing interface after the target attribute control in the initial attribute selection interface is triggered, it further includes:
displaying an animation of an attribute change during the processing of the object to be processed.

For example, the apparatus further includes a fifth display module, including:
displaying a time-limited processing interface, which includes a time-limited processing control; and
after the time-limited processing control is triggered, displaying a second sharing control in the attribute changing interface displayed before the time-limited processing interface, and displaying a time-limited interface after the second sharing control is triggered;
after receiving a processing operation in the time-limited interface, responding to the processing operation;
when the processing result satisfies a fourth preset condition, displaying the target attribute processing interface,
where the attribute changing interface includes an initial attribute changing interface and an intermediate attribute changing interface.

The object processing apparatus may execute the object processing method provided in any embodiment of the present disclosure, and has a corresponding functional module and beneficial effect for implementing the method.

FIG. 12 is a structural schematic diagram of an electronic device provided by an embodiment of the present disclosure. FIG. 12 shows the structure schematic diagram suitable for achieving the electronic device 400 in the embodiment of the present disclosure. The electronic device 400 in the embodiment of the present disclosure may include but not be limited to a mobile terminal such as a mobile phone, a notebook computer, a digital broadcasting receiver, a personal digital assistant (PDA), a portable android device (PAD), a portable multimedia player (PMP), a vehicle terminal (such as a vehicle navigation terminal), and a fixed terminal such as a digital television (TV) and a desktop computer. The electronic device 400 shown in FIG. 12 is only an example and should not impose any limitations on the functions and use scopes of the embodiments of the present disclosure.

As shown in FIG. 12, the electronic device 400 may include a processing apparatus (such as a central processing unit, and a graphics processor) 401, it may execute a plurality appropriate actions and processes according to a program stored in a read-only memory (ROM) 402 or a program loaded from a storage apparatus 408 to a random access memory (RAM) 403. One or more processing apparatuses 401 implement the method provided by the present disclosure. In RAM 403, a plurality of programs and data required for operations of the electronic device 400 are also stored. The processing apparatus 401, ROM 402, and RAM 403 are connected to each other by a bus 404. An input/output (I/O) interface 405 is also connected to the bus 404.

Typically, the following apparatuses may be connected to the I/O interface 405: an input apparatus 406 such as a touch screen, a touchpad, a keyboard, a mouse, a camera, a microphone, an accelerometer, and a gyroscope; an output apparatus 407 such as a liquid crystal display (LCD), a loudspeaker, and a vibrator; a storage apparatus 408 such as a magnetic tape, and a hard disk drive; and a communication apparatus 409. The communication apparatus 409 may allow the electronic device 400 to wireless-communicate or wire-communicate with other devices so as to exchange data. Although FIG. 12 shows the electronic device 400 with a plurality of apparatuses, it is not required to implement or possess all the apparatuses shown. Alternatively, it may implement or possess the more or less apparatuses.

According to the embodiment of the present disclosure, the process described above with reference to the flowchart may be achieved as a computer software program. For example, an embodiment of the present disclosure includes a computer program product, it includes a computer program carried on a computer-readable medium, and the computer program includes program codes for executing the method shown in the flowchart. In such an embodiment, the computer program may be downloaded and installed from the network by the communication apparatus 409, or installed from the storage apparatus 408, or installed from ROM 402. When the computer program is executed by the processing apparatus 401, the above functions defined in the method in the embodiments of the present disclosure are executed. The computer-readable storage medium may be a non-transitory computer-readable storage medium.

It should be noted that the above computer-readable medium in the present disclosure may be a computer-readable signal medium, a computer-readable storage medium, or any combinations of the two. The computer-readable storage medium may be, for example, but not limited to, a system, an apparatus or a device of electricity, magnetism, light, electromagnetism, infrared, or semiconductor, or any combinations of the above. More examples of the computer-readable storage medium may include but not be limited to: an electric connector with one or more wires, a portable computer magnetic disk, a hard disk drive, a RAM, a ROM, an erasable programmable read-only memory (EPROM or flash memory), an optical fiber, a compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt a plurality of forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the electronic device 400 described above, or may exist alone without being assembled into the electronic device 400.

The above-mentioned computer-readable medium stores one or more computer programs, and when the one or more programs are executed by a processing apparatus, the following method is implemented. The above-mentioned computer-readable medium carries one or more programs which, when executed by the electronic device, cause the electronic device 400. The computer program code for executing the operation of the present disclosure may be written in one or more programming languages or combinations thereof, the above programming language includes but is not limited to object-oriented programming languages such as Java, Smalltalk, and C++, and also includes conventional procedural programming languages such as a “C” language or a similar programming language. The program code may be completely executed on the user's computer, partially executed on the user's computer, executed as a standalone software package, partially executed on the user's computer and partially executed on a remote computer, or completely executed on the remote computer or server. In the case involving the remote computer, the remote computer may be connected to the user's computer by any types of networks, including local area network (LAN) or wide area network (WAN), or may be connected to an external computer (such as connected by using an internet service provider through the Internet).

The flowcharts and the block diagrams in the drawings show possibly achieved system architectures, functions, and operations of systems, methods, and computer program products according to a plurality of embodiments of the present disclosure. At this point, each box in the flowchart or the block diagram may represent a module, a program segment, or a part of a code, the module, the program segment, or a part of the code contains one or more executable instructions for achieving the specified logical functions. It should also be noted that in some alternative implementations, the function indicated in the box may also occur in a different order from those indicated in the drawings. For example, two consecutively represented boxes may actually be executed basically in parallel, and sometimes it may also be executed in an opposite order, this depends on the function involved. It should also be noted that each box in the block diagram and/or the flowchart, as well as combinations of the boxes in the block diagram and/or the flowchart, may be achieved by using a dedicated hardware-based system that performs the specified function or operation, or may be achieved by using combinations of dedicated hardware and computer instructions.

The involved modules described in the embodiments of the present disclosure may be achieved by a mode of software, or may be achieved by a mode of hardware. The name of the module does not constitute a limitation for the module itself in a case.

The functions described above in this article may be at least partially executed by one or more hardware logic components. For example, non-limiting exemplary types of the hardware logic component that may be used include: a field programmable gate array (FPGA), an application specific integrated circuit (ASIC), an application specific standard part (ASSP), a system on chip (SOC), a complex programmable logic device (CPLD) and the like.

In the context of the present disclosure, the machine-readable medium may be a visible medium, and it may contain or store a program for use by or in combination with an instruction executive system, apparatus, or device. The machine-readable medium may be a machine-readable signal medium or a machine-readable storage medium. The machine-readable medium may include but not limited to an electronic, magnetic, optical, electromagnetic, infrared, or semiconductor system, apparatus, or device, or any suitable combinations of the above. More specific examples of the machine-readable storage medium may include an electric connector based on one or more wires, a portable computer disk, a hard disk drive, RAM, ROM, EPROM (or a flash memory), an optical fiber, CD-ROM, an optical storage device, a magnetic storage device, or any suitable combinations of the above.

According to one or more embodiments of the present disclosure, Example 1 provides an object processing method, including:
displaying an object-to-be-processed selection interface;
after a confirmation control in the object-to-be-processed selection interface is triggered, displaying an initial attribute selection interface of a selected object to be processed, where the initial attribute selection interface includes an initial attribute control and a target attribute control, and the initial attribute control is configured to process the selected object to be processed with an initial attribute;
after the target attribute control in the initial attribute selection interface is triggered, displaying an initial attribute changing interface; and
after a processing of the selected object to be processed through the initial attribute changing interface satisfies a first preset condition, displaying a target attribute processing interface, where the target attribute processing interface is provided for a user to process the selected object to be processed with a target attribute.

According to one or more embodiments of the present disclosure, Example 2 provides the method according to Example 1, where
the initial attribute changing interface includes an initial processing control, an initial attribute processing interface is displayed after the initial processing control is triggered, and the initial attribute processing interface is provided for the user to process the selected object to be processed with the initial attribute.

According to one or more embodiments of the present disclosure, Example 3 provides the method according to Example 1, where
the initial attribute changing interface includes a first sharing control, a sharing interface is displayed after the first sharing control is triggered; and
after a sharing operation in the sharing interface is received, the sharing operation is responded.

According to one or more embodiments of the present disclosure, Example 4 provides the method according to Example 3, and the method further includes:
when a response result satisfies a second preset condition, displaying an intermediate attribute selection interface, where the intermediate attribute selection interface includes an intermediate attribute control and a target attribute control, and the intermediate attribute control is configured to process the selected object to be processed with an intermediate attribute; and
after the target attribute control in the intermediate attribute selection interface is triggered, displaying an intermediate attribute changing interface.

According to one or more embodiments of the present disclosure, Example 5 provides the method according to Example 4, where
the intermediate attribute changing interface includes an intermediate processing control, an intermediate attribute processing interface is displayed after the intermediate processing control is triggered, and the intermediate attribute processing interface is provided for the user to process the object to be processed with the intermediate attribute.

According to one or more embodiments of the present disclosure, Example 6 provides the method according to Example 3, where
the when a processing of the selected object to be processed through the initial attribute changing interface satisfies a first preset condition, displaying a target attribute processing interface includes:
when a response result satisfies the first preset condition during the processing of the selected object to be processed, displaying the target attribute processing interface.

According to one or more embodiments of the present disclosure, Example 7 provides the method according to Example 3, and the method further includes:
when the response result satisfies a third preset condition within a set duration, displaying a reprocessing selection interface, where the reprocessing selection interface includes a reprocessing control and a set attribute control, the initial attribute changing interface is displayed again after the reprocessing control is triggered, a corresponding attribute processing interface is displayed after the set attribute control is triggered, and the attribute processing interface is provided for the user to process the selected object to be processed with a set attribute.

According to one or more embodiments of the present disclosure, Example 8 provides the method according to Example 1,
before displaying an initial attribute changing interface after the target attribute control in the initial attribute selection interface is triggered, the method further includes:
displaying an animation of an attribute change during a processing of the object to be processed.

According to one or more embodiments of the present disclosure, Example 9 provides the method according to Example 1, and the method further includes:
displaying a time-limited processing interface, the time-limited processing interface including a time-limited processing control;
after the time-limited processing control is triggered, displaying a second sharing control in the attribute changing interface displayed before the time-limited processing interface, and displaying a time-limited interface after the second sharing control is triggered;
after a processing operation in the time-limited interface is received, responding to the processing operation;
when a processing result satisfies a fourth preset condition, displaying the target attribute processing interface,
where the attribute changing interface includes the initial attribute changing interface and an intermediate attribute changing interface.

According to one or more embodiments of the present disclosure, Example 10 provides an object processing apparatus, including:
a first display module, configured to display an object-to-be-processed selection interface;
a second display module, configured to, in response to determining that a confirmation control in the object-to-be-processed selection interface is triggered, display an initial attribute selection interface of a selected object to be processed, where the initial attribute selection interface includes an initial attribute control and a target attribute control, and the initial attribute control is configured to process the selected object to be processed with an initial attribute;
a third display module, configured to, in response to determining that the target attribute control in the initial attribute selection interface is triggered, display an initial attribute changing interface; and
a fourth display module configured to, in response to determining that a processing of the selected object to be processed through the initial attribute changing interface satisfies a first preset condition, display a target attribute processing interface, where the target attribute processing interface is provided for a user to process the selected object to be processed with a target attribute.

According to one or more embodiments of the present disclosure, Example 11 provides an electronic device, including:
one or more processing apparatuses;
a storage apparatus configured to store one or more programs,
where the one or more programs upon being executed by the one or more processing apparatuses implement the method according to any one of examples 1-9.

According to one or more embodiments of the present disclosure, Example 13 provides a computer readable medium, storing computer programs, where the computer programs upon being executed by a processing apparatus, implement the method according to any one of examples 1-9.

In addition, while the plurality of operations have been described in a particular order, it shall not be construed as requiring that such operations are performed in the stated specific order or sequence. Under certain circumstances, multitasking and parallel processing may be advantageous. Similarly, while the plurality of specific implementation details are included in the above discussions, these shall not be construed as limitations to the present disclosure. Some features described in the context of a separate embodiment may also be combined in a single embodiment. Rather, the plurality of features described in the context of a single embodiment may also be implemented separately or in any appropriate sub-combination in a plurality of embodiments.

1. An object processing method, comprising:
displaying an object-to-be-processed selection interface;
in response to a confirmation control in the object-to-be-processed selection interface being triggered, displaying an initial attribute selection interface of a selected object to be processed, wherein the initial attribute selection interface comprises an initial attribute control and a target attribute control, and the initial attribute control is configured to process the selected object to be processed with an initial attribute;
in response to the target attribute control in the initial attribute selection interface being triggered, displaying an initial attribute changing interface; and
in response to a processing of the selected object to be processed through the initial attribute changing interface satisfying a first preset condition, displaying a target attribute processing interface, wherein the target attribute processing interface is provided for a user to process the selected object to be processed with a target attribute.

2. The method according to claim 1, wherein
the initial attribute changing interface comprises an initial processing control, an initial attribute processing interface is displayed after the initial processing control is triggered, and the initial attribute processing interface is provided for the user to process the selected object to be processed with the initial attribute.

3. The method according to claim 1, wherein
the initial attribute changing interface comprises a first sharing control, and a sharing interface is displayed after the first sharing control is triggered; and the method further comprises:
in response to receiving a sharing operation in the sharing interface, responding the sharing operation.

4. The method according to claim 3, further comprising:
in response to a response result satisfying a second preset condition, displaying an intermediate attribute selection interface, wherein the intermediate attribute selection interface comprises an intermediate attribute control and a target attribute control, and the intermediate attribute control is configured to process the selected object to be processed with an intermediate attribute; and
after the target attribute control in the intermediate attribute selection interface is triggered, displaying an intermediate attribute changing interface.

5. The method according to claim 4, wherein
the intermediate attribute changing interface comprises an intermediate processing control, an intermediate attribute processing interface is displayed after the intermediate processing control is triggered, and the intermediate attribute processing interface is provided for the user to process the selected object to be processed with the intermediate attribute.

6. The method according to claim 3, wherein the in response to a processing of the selected object to be processed through the initial attribute changing interface satisfying a first preset condition, displaying a target attribute processing interface comprises:
in response to a response result satisfying the first preset condition during the processing of the selected object to be processed, displaying the target attribute processing interface.

7. The method according to claim 3, further comprising:
in response to the response result satisfying a third preset condition, displaying a reprocessing selection interface, wherein the reprocessing selection interface comprises a reprocessing control and a set attribute control, the initial attribute changing interface is displayed again after the reprocessing control is triggered, a corresponding attribute processing interface is displayed after the set attribute control is triggered, and the attribute processing interface is provided for the user to process the selected object to be processed with a set attribute.

8. The method according to claim 1, before the in response to the target attribute control in the initial attribute selection interface being triggered, displaying an initial attribute changing interface, further comprising:
displaying an animation of an attribute change during a processing of the object to be processed.

9. The method according to claim 1, further comprising:
displaying a time-limited processing interface, wherein the time-limited processing interface comprises a time-limited processing control;
in response to the time-limited processing control being triggered, displaying a second sharing control in the attribute changing interface displayed before the time-limited processing interface, and displaying a time-limited interface after the second sharing control is triggered;
in response to receiving a processing operation in the time-limited interface, responding to the processing operation;
in response to a processing result satisfying a fourth preset condition, displaying the target attribute processing interface,
wherein the attribute changing interface comprises the initial attribute changing interface and an intermediate attribute changing interface.

10. (canceled)

11. An electronic device, comprising:
one or more processing apparatuses;
a storage apparatus configured to store one or more programs,
wherein the one or more programs upon being executed by the one or more processing apparatuses implement an object processing method, and the method comprises:
displaying an object-to-be-processed selection interface;
in response to a confirmation control in the object-to-be-processed selection interface being triggered, displaying an initial attribute selection interface of a selected object to be processed, wherein the initial attribute selection interface comprises an initial attribute control and a target attribute control, and the initial attribute control is configured to process the selected object to be processed with an initial attribute:
in response to the target attribute control in the initial attribute selection interface being triggered, displaying an initial attribute changing interface; and
in response to a processing of the selected object to be processed through the initial attribute changing interface satisfying a first preset condition, displaying a target attribute processing interface, wherein the target attribute processing interface is provided for a user to process the selected object to be processed with a target attribute.

12. A non-transitory computer-readable medium, storing computer programs, wherein the computer programs upon being executed by a processing apparatus, implement an object processing method, and the method comprises:
displaying an object-to-be-processed selection interface;
in response to a confirmation control in the object-to-be-processed selection interface being triggered, displaying an initial attribute selection interface of a selected object to be processed, wherein the initial attribute selection interface comprises an initial attribute control and a target attribute control, and the initial attribute control is configured to process the selected object to be processed with an initial attribute:
in response to the target attribute control in the initial attribute selection interface being triggered, displaying an initial attribute changing interface; and
in response to a processing of the selected object to be processed through the initial attribute changing interface satisfying a first preset condition, displaying a target attribute processing interface, wherein the target attribute processing interface is provided for a user to process the selected object to be processed with a target attribute.

13. The electronic device according to claim 11, wherein
the initial attribute changing interface comprises an initial processing control, an initial attribute processing interface is displayed after the initial processing control is triggered, and the initial attribute processing interface is provided for the user to process the selected object to be processed with the initial attribute.

14. The electronic device according to claim 11, wherein
the initial attribute changing interface comprises a first sharing control, and a sharing interface is displayed after the first sharing control is triggered; and the method further comprises:
in response to receiving a sharing operation in the sharing interface, responding the sharing operation is responded.

15. The electronic device according to claim 14, wherein the method further comprises:
in response to a response result satisfying a second preset condition, displaying an intermediate attribute selection interface, wherein the intermediate attribute selection interface comprises an intermediate attribute control and a target attribute control, and the intermediate attribute control is configured to process the selected object to be processed with an intermediate attribute; and
after the target attribute control in the intermediate attribute selection interface is triggered, displaying an intermediate attribute changing interface.

16. The electronic device according to claim 15, wherein
the intermediate attribute changing interface comprises an intermediate processing control, an intermediate attribute processing interface is displayed after the intermediate processing control is triggered, and the intermediate attribute processing interface is provided for the user to process the selected object to be processed with the intermediate attribute.

17. The electronic device according to claim 14, wherein the in response to a processing of the selected object to be processed through the initial attribute changing interface satisfying a first preset condition, displaying a target attribute processing interface comprises:
in response to a response result satisfying the first preset condition during the processing of the selected object to be processed, displaying the target attribute processing interface.

18. The electronic device according to claim 14, wherein the method further comprises:
in response to the response result satisfying a third preset condition, displaying a reprocessing selection interface, wherein the reprocessing selection interface comprises a reprocessing control and a set attribute control, the initial attribute changing interface is displayed again after the reprocessing control is triggered, a corresponding attribute processing interface is displayed after the set attribute control is triggered, and the attribute processing interface is provided for the user to process the selected object to be processed with a set attribute.

19. The electronic device according to claim 11, wherein before the in response to the target attribute control in the initial attribute selection interface being triggered, displaying an initial attribute changing interface, the method further comprises:
displaying an animation of an attribute change during a processing of the object to be processed.

20. The electronic device according to claim 11, wherein the method further comprises:
displaying a time-limited processing interface, wherein the time-limited processing interface comprises a time-limited processing control;
in response to the time-limited processing control being triggered, displaying a second sharing control in the attribute changing interface displayed before the time-limited processing interface, and displaying a time-limited interface after the second sharing control is triggered;
in response to receiving a processing operation in the time-limited interface, responding to the processing operation;
in response to a processing result satisfying a fourth preset condition, displaying the target attribute processing interface,
wherein the attribute changing interface comprises the initial attribute changing interface and an intermediate attribute changing interface.
